(19) United States
(12) Patent Application Publication
(10) Pub. No.: US 2020/0183368 A1
(43) Pub. Date: Jun. 11, 2020

(54) INFORMATION PROCESSOR, MANUFACTURING ASSISTANCE SYSTEM, AND VALVE DEVICE ASSEMBLY METHOD

(71) Applicant: FUJIKIN INCORPORATED, Osaka (JP)

(72) Inventors: Tatsuhiko SATO, Osaka (JP); Tomohiro NAKATA, Osaka (JP); Hidenobu SATO, Osaka (JP)

(21) Appl. No.: 16/778,599

(22) Filed: Jan. 31, 2020

Related U.S. Application Data
(63) Continuation of application No. PCT/JP2018/026148, filed on Jul. 11, 2018.

(30) Foreign Application Priority Data
Jul. 31, 2017 (JP) 2017-147328

(51) Int. Cl. G05B 19/418; G06T 7/00

(52) U.S. Cl. CPC G05B 19/4188; G05B 19/41875; G05B 19/41865; G06T 7/0004

(57) ABSTRACT

An information processor includes a controller that is configured to: produce, on the basis of use information of a device manufactured under a manufacturing condition based on spec information, appropriate spec information representing an appropriate spec which is appropriate to the device; and determine a manufacturing condition for the device on the basis of the appropriate spec information.

### CROSS REFERENCE TO RELATED APPLICATION

This application is a bypass continuation application of International Application No. PCT/JP2018/026148, filed Jul. 11, 2018, which claims priority to Japanese Patent Application No. 2017-147328, filed Jul. 31, 2017, the entire contents of which being incorporated herein by reference.

### TECHNICAL FIELD

The present disclosure relates to an information processor, a manufacturing assistance system and a valve device assembly method.

### BACKGROUND

In semiconductor processes, various recipes are used. When a different recipe is used, performance required of a valve device used in a semiconductor process is also different for each recipe. Accordingly, it is preferred to manufacture respective valve devices appropriate to the individual semiconductor processes.

### SUMMARY

To manufacture valve devices appropriate to each semiconductor process, it is required to prepare a paper manufacturing manual for each valve device. However, such preparation results in carrying a large amount of paper into a clean room, which is unrealistic.

Accordingly, a high-spec valve device is mass-produced to be used in semiconductor processes, but the specification is too high and therefore the valve device becomes expensive.

It is therefore an object of the present disclosure to provide a technique which allows a device having an appropriate spec to be easily manufactured.

An information processor in accordance with one or more embodiments includes a controller that is configured to: produce, on the basis of use information of a device manufactured under a manufacturing condition based on spec information, appropriate spec information representing an appropriate spec which is appropriate to the device; and determine a manufacturing condition for the device on the basis of the appropriate spec information.

A manufacturing assistance system in accordance with one or more embodiments includes the information processor; and a display device which displays the instruction information.

A valve device assembly method in accordance with one or more embodiments using the manufacturing assistance system. The device is a valve device. The manufacturing condition includes at least any one of a physical value of a valve element of the valve device, a size of the valve element, a range of a temperature around the valve device during manufacturing thereof, and a leakage detection method for the valve device.

### BRIEF DESCRIPTION OF THE DRAWINGS

In the drawings:

FIG. 1 is a configuration diagram of a manufacturing assistance system including a manufacturing instruction information production device according to an embodiment of the present disclosure;

FIG. 2 is an external perspective view of a fluid control apparatus;

FIG. 3 is a front view of each of valve devices;

FIG. 4 is a view illustrating an example of a configuration of a use information table;

FIG. 5 is a view illustrating an example of a configuration of a spec information table;

FIG. 6 is a view illustrating an example of a configuration of an appropriate spec information table;

FIG. 7 is a view illustrating an example of a configuration of a manufacturing condition table;

FIG. 8 is a flow chart illustrating a procedure of an instruction information production process; and

FIG. 9 is an external view of a head-mounted display.

### DETAILED DESCRIPTION

Referring to the drawings, a description will be given of an information processor 1 according an embodiment of the present disclosure.

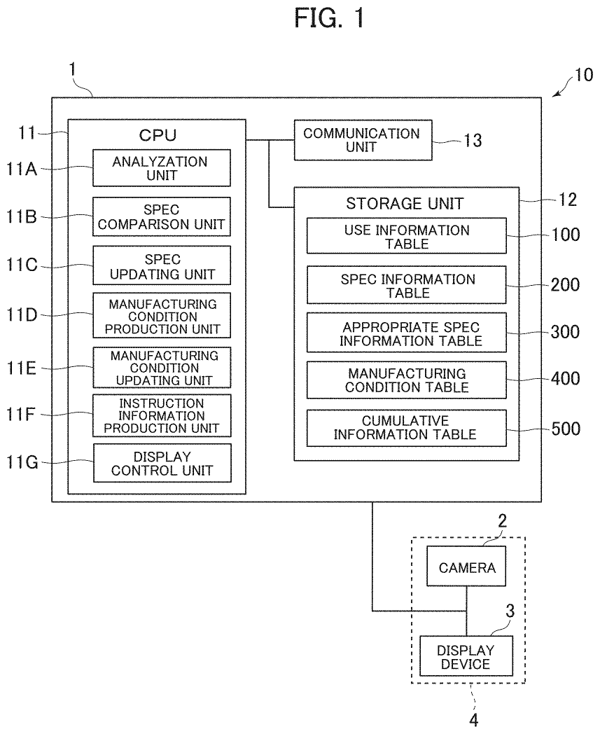

FIG. 1 is a configuration diagram of a manufacturing assistance system 10 including the information processor 1 according to the present embodiment.

The information processor 1 according to the embodiment of the present disclosure is a device which produces manufacturing instruction information related to valve devices 30 provided in a fluid control apparatus 20. The fluid control apparatus 20 is a device provided in a semiconductor manufacturing device. Each of the valve devices 30 is an example of a device.

First, a description will be given of the fluid control apparatus 20 and the valve devices 30.

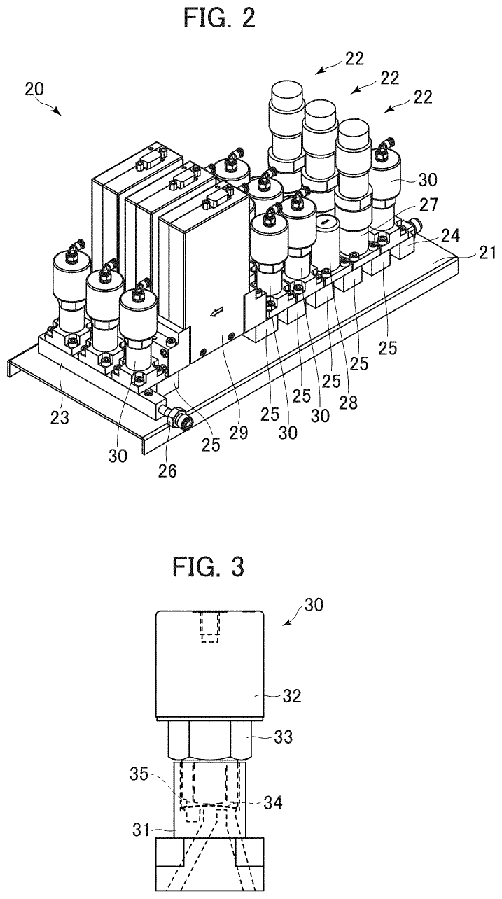

FIG. 2 is an external perspective view of the fluid control apparatus 20. FIG. 3 is a front view of each of the valve devices 30.

As illustrated in FIG. 2, the fluid control apparatus 20 includes a base plate 21, a plurality of (three) gas lines 22, and a gas-out manifold 23. Each of the gas lines 22 has the same configuration, and therefore only one of the plurality of gas lines 22 will be described below.

As illustrated in FIG. 2, the gas line 22 includes a plurality of joints 24 and 25 and a plurality of fluid control devices 27 to 30.

The plurality of joints 24 and 25 include the inlet joint 24 serving as an inlet for a process gas and the plurality of block-shaped joints 25 disposed between the inlet joint 24 and the gas-out manifold 23. The plurality of joints 24 and 25 are provided so as to be arranged in a line over the base plate 21 and are fixed to the base plate 21. The gas-out manifold 23 is connected to an outlet pipe 26.

The plurality of fluid control devices 27 to 30 include the manual regulator (pressure reducing valve device) 27, the filter 28, the flow rate control device (e.g., mass flow controller (MFC)) 29, and the automatic valve devices (e.g., fluid-driven automatic valve devices) 30. Each of the fluid control devices 27 to 30 is connected to the joints 24 and 25. The gas flown in from the inlet joint 24 passes through the fluid control devices 27 to 30, the plurality of joints 25, and the gas-out manifold 23 to be supplied to a chamber (not illustrated). In the regulator 27 or the mass flow controller 29, a flow rate sensor (not illustrated) which senses a flow rate of the gas is provided.

FIG. 3 is a front view of each of the valve devices 30.

As illustrated in FIG. 3, the valve device 30 includes a body 31, an actuator 32, a bonnet 33 connected to each of the body 31 and the actuator 32 and rotated by a torque wrench (illustration of which is omitted), and a diaphragm 34 having an outer peripheral edge portion thereof pressed between the body 31 and the bonnet 33. The valve device 30 is a valve device which is opened/closed by a drive fluid supplied to the actuator 32 from an outside thereof. In the valve device 30, a sensor unit 35 is provided. The sensor unit 35 includes a pressure sensor which senses a pressure of the gas, a temperature sensor which senses a temperature of the gas, and a displacement sensor which senses movement of the diaphragm 34. The diaphragm 34 corresponds to a valve element.

Next, referring to FIG. 1, a description will be given of a configuration of a manufacturing assistance system 10 including the information processor 1. As illustrated in FIG. 1, the manufacturing assistance system 10 includes the information processor 1, a camera 2, and a display device 3, which are configured to be wiredly or wirelessly communicative with each other.

The camera 2 is, e.g., a video camera configured to be capable of recording a video, record a video of the valve devices 30 during manufacturing thereof, and transmit the recorded video to the information processor 1. The display device 3 has a display and displays instruction information related to manufacturing of the valve devices 30 which is transmitted from the information processor 1.

The information processor 1 includes a central processing unit (CPU) 11, a storage unit 12, and a communication unit 13, which are connected to each other by a bus.

The CPU 11 as a controller reads and executes a program stored in the storage unit 12 to control the information processor 1 and the manufacturing assistance system 10.

The storage unit 12 stores a program related to an instruction information production process described later. The program is read and executed by the CPU 11 to implement respective functions of individual processing units 11A to 11G of the CPU 11.

The storage unit 12 also stores various tables related to use information of the valve devices 30, spec (specification) information thereof, appropriate spec (specification) information for the valve devices 30, manufacturing conditions therefor, and cumulative information related to the valve devices 30.

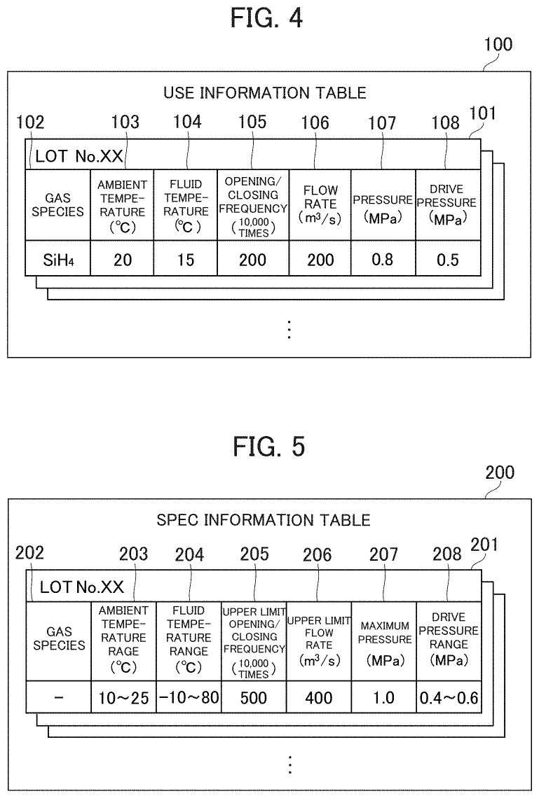

FIG. 4 is a view illustrating an example of a configuration of a use information table 100.

The use information table 100 stores, e.g., the use information of the valve devices 30 located most upstream and most downstream in each of the gas lines 22 of the fluid control apparatus 20 and has a plurality of in-use valve tables 101 provided therein to correspond to the individual valve devices 30. To each of the in-use valve tables 101, a lot No. of the corresponding valve device 30 is added.

Each of the in-use valve tables 101 stores, as items of use information, a gas species 102, an ambient temperature 103, a fluid temperature 104, an opening/closing frequency 105, a flow rate 106, a pressure 107, and a drive pressure 108.

The gas species 102 indicates a species of the gas used in the valve device 30. The ambient temperature 103 indicates an average temperature (° C.) around the valve device 30. The fluid temperature 104 indicates an average temperature (° C.) of the gas flowing in the valve device 30. The opening/closing frequency 105 indicates the number of times (total number of times) the valve device 30 is opened/closed during a use period. The flow rate 106 indicates a flow rate (m³/s) of the gas that has flown in the valve device 30 during the use period. The pressure 107 indicates an average pressure (MPa) of the gas flowing in the valve device 30. The drive pressure 108 indicates an average drive pressure (MPa) of a drive fluid supplied to the actuator 32 to open/close the valve device 30.

The sensor unit 35 provided in each of the valve devices 30 and a flow rate sensor (not illustrated) provided in the regulator 27 or the mass flow controller 29 acquire the ambient temperature 103, the fluid temperature 104, and the like, which are stored in the storage unit provided in the fluid control apparatus 20. The ambient temperature 103, the fluid temperature 104, and the like may also be transmitted by wireless communication to another external information processor without being stored in the storage unit. Then, the fluid control apparatus 20 provided in the semiconductor manufacturing device is used for a predetermined period (e.g., one week), and produces the use information table 100 on the basis of data stored in the storage unit. The use information table 100 may also be produced by the information processor 1 or produced by another external information processor and input to the information processor 1. In the use information table 100, the temperature and the pressure are the average values, but may also be in respective ranges (upper limits and lower limits) of the temperature and the pressure during the use period.

FIG. 5 is a view illustrating an example of a configuration of a spec information table 200.

Each of the spec information tables 200 stores spec (specification) information of the valve device 30 the use information of which is stored in the use information table 100. Accordingly, in the spec information table 200, spec valve tables 201 corresponding to the individual valve devices 30 are provided.

The spec valve table 201 stores, as items of the spec information, a gas species 202, an ambient temperature range 203, a fluid temperature range 204, an upper limit opening/closing frequency 205, an upper limit flow rate 206, a maximum pressure 207, and a drive pressure range 208.

The gas species 202 indicates the species of the gas used in each of the valve devices 30. However, since a gas to be used is unknown during manufacturing, the gas species 202 remains empty. The ambient temperature range 203 indicates an ambient temperature range (° C.) in which the valve device 30 can be used. The fluid temperature range 204 indicates a temperature range (° C.) of the gas caused to flow in the valve device 30. The upper limit opening/closing frequency 205 indicates an upper limit of the number of times (total number of times) the valve device 30 is opened/closed during the use period. The upper limit flow rate 206 indicates an upper limit of a flow rate (m³/s) of the gas flowing in the valve device 30 during the use period. The maximum pressure 207 indicates a maximum pressure (MPa) of the gas which can be allowed to flow in the valve device 30. The drive pressure 208 indicates a range of a drive pressure (MPa) of the drive fluid supplied to the actuator 32 to open/close the valve device 30.

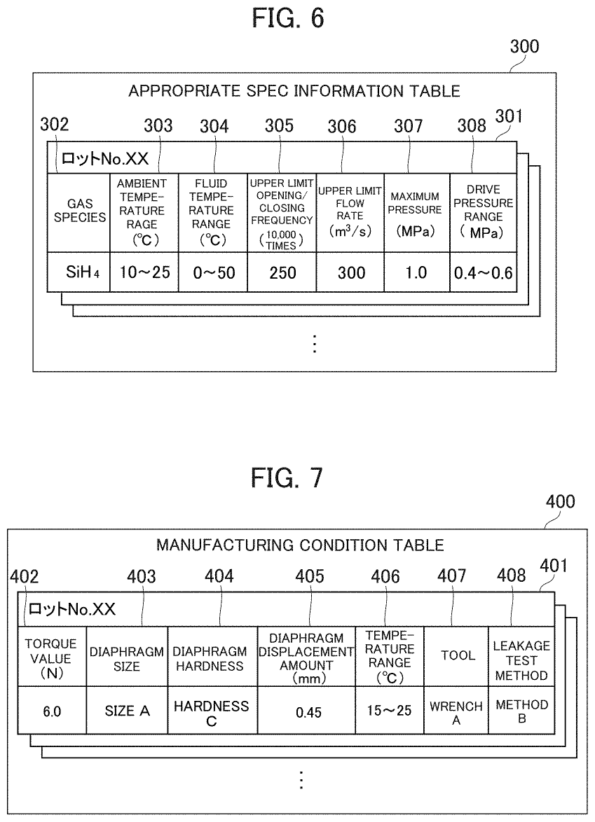

FIG. 6 is a view illustrating an example of a configuration of an appropriate spec information table 300.

The appropriate spec information table 300 is produced on the basis of the use information table 100 as described later, and includes respective appropriate spec valve tables 301 corresponding to the individual valve devices 30.

Each of the appropriate spec valve tables 301 stores, as appropriate spec information based on the use information, a gas species 302, an ambient temperature range 303, a fluid temperature range 304, an upper limit opening/closing frequency 305, an upper limit flow rate 306, a maximum pressure 307, and a drive pressure range 308. The items stored in each of the appropriate spec valve tables 301 are the same as the items stored in the spec valve table 201, and therefore a description thereof is omitted. Note that each of the appropriate spec valve tables 301 has a gas to be used that has been input thereto.

FIG. 7 is a view illustrating an example of a configuration of a manufacturing condition table 400.

The manufacturing condition table 400 stores manufacturing conditions for manufacturing the individual valve devices 30. Accordingly, the manufacturing condition table 400 includes manufacturing valve tables 401 corresponding to the individual valve devices 30.

Each of the manufacturing valve tables 401 stores, as items of manufacturing information, a torque value 402, a diaphragm size 403, a diaphragm hardness 404, a diaphragm displacement amount 405, a temperature range 406, a tool 407, and a leakage test method 408.

The torque value 402 indicates a torque value when the bonnet 33 is screwed into the body 31. Depending on the torque value, a shape of the diaphragm 34 having the outer peripheral edge portion thereof pressed varies. For example, when the torque value is increased, the diaphragm 34 has a steeply sloped mountain shape. Consequently, an amount of stroke of the valve device 30 and the gas flow rate increase to degrade a durability of the diaphragm 34. Meanwhile, when the torque value is reduced, the diaphragm 34 has a gently sloped mountain shape. Consequently, the amount of stroke of the valve device 30 and the gas flow rate decrease, and the durability of the diaphragm 34 therefore increases.

The diaphragm size 403 indicates a size of the diaphragm 34. Since the size of the diaphragm 34 has a slight error depending on a manufacturing lot, the size of the diaphragm 34 is classified into sizes A to C which are progressively larger. As the size of the diaphragm 34 is larger, the diaphragm 34 has a more gently sloped mountain shape. Consequently, the amount of stroke of the valve device 30 and the gas flow rate decrease. Meanwhile, as the size of the diaphragm 34 is smaller, the diaphragm 34 has a more steeply sloped mountain shape. Consequently, the amount of stroke of the valve device 30 and the gas flow rate increase.

The diaphragm hardness 404 indicates a hardness (Vickers hardness) of the diaphragm 34. Since the hardness of the diaphragm 34 has a slight error depending on the manufacturing lot, the hardnesses of the diaphragms 34 are classified into hardnesses A to C which are progressively higher. As the hardness of the diaphragm 34 is higher, the diaphragm 34 has a more steeply sloped mountain shape. Consequently, the amount of stroke of the valve device 30 and the gas flow rate increase. Meanwhile, as the hardness of the diaphragm 34 is lower, the diaphragm 34 has a more gently sloped mountain shape. Consequently, the amount of stroke of the valve device 30 and the gas flow rate decrease. The hardness of the diaphragm 34 corresponds to a physical value of the valve element.

The diaphragm displacement amount 405 indicates a distance traveled by the diaphragm 34 of the valve device 30 before the diaphragm 34 is seated on a valve seat, i.e., the amount of stroke of the valve device 30. The diaphragm displacement amount 405 serves as an important item in determining a Cv value of the valve device 30 in use. In addition, as the diaphragm displacement amount 405 is larger, the diaphragm 34 has a more steeply sloped mountain shape to increase the gas flow rate while, as the diaphragm displacement amount 405 is smaller, the diaphragm 34 has a more gently sloped mountain shape to reduce the gas flow rate.

The temperature range 406 indicates a range of a temperature around the valve device 30 during the manufacturing thereof.

The tool 407 indicates a type of a wrench used when the bonnet 33 is screwed into the body 31.

The leakage test method 408 indicates a method for a leakage test which is performed after the valve devices 30 are completed. Depending on the gas species caused to flow in each of the valve devices 30, the leakage test is changed. For example, in the valve device 30 in which monosilane (SiH₄) is caused to flow, a test more stringent than a leakage test performed on the valve device 30 in which nitrogen is caused to flow is performed. The method for the leakage test corresponds to a leakage detection method.

A cumulative information table 500 stores the use information tables 100, the spec information tables 200, the appropriate spec information table 300, and the manufacturing condition tables 400 which are related to the valve devices for which instruction information was previously produced in the information processor 1. After the instruction information production process described later is performed, the used tables are stored.

The communication unit 13 performs communication with each of the camera 2 and the display device 3, receives a video transmitted from the camera 2, and transmits information from the display control unit 11G of the CPU 11 to the display device 3.

The CPU 11 includes the analyzation unit 11A, the spec comparison unit 11B, the spec updating unit 11C, the manufacturing condition production unit 11D, the manufacturing condition updating unit 11E, the instruction information production unit 11F, and the display control unit 11G.

The analyzation unit 11A analyzes the use information stored in the use information table 100 and produces appropriate spec information on the basis of each of the spec information stored in the spec information table 200 and the cumulative information stored in the cumulative information table 500. For example, it may also be possible to compare each of the items of the use information stored in the use information table 100 to the corresponding one of the items of the spec information of the valve device 30. For the matched items, the spec as the appropriate spec, while using, for the unmatched items, a spec obtained by changing the spec so as to achieve a match therebetween.

When the opening/closing frequency 105 of the use information has not been over the upper limit opening/closing frequency 205 of the spec information or has not been significantly under the upper limit opening/closing frequency 205 of the spec information for the valve device having the same spec as that of the valve device 30, the upper limit opening/closing frequency 305 of the appropriate spec information need not be produced on the basis of the opening/closing frequency 105 of the use information. It may also be possible to extract, from the appropriate spec information of the cumulative information, a spec which matches all the items of the use information as the appropriate spec.

As the amount of stroke of the valve device 30 is smaller, the displacement amount of the diaphragm 34 is smaller and a repetitive stress is smaller. Accordingly, it is possible to increase the durability thereof, i.e., the usable number of times the valve device 30 is opened/closed. However, when the amount of stroke of the valve device 30 is reduced, a pressure loss is large and a high flow rate cannot be ensured, and therefore the durability and the flow rate have a tradeoff relationship therebetween.

Specifically, the individual items 102 to 108 of the use information in FIG. 4 are compared to the individual items 202 to 208 of the spec information in FIG. 5. The items 103, 107, and 108 of the use information match the items 203, 207, and 208 of the spec information, and accordingly the spec is used as the appropriate spec. Meanwhile, the items 102 and 104 to 106 of the use information do not match the items 202 and 204 to 206 of the spec information, and accordingly the spec changed so as to achieve matches therebetween is used as the appropriate spec.

The spec comparison unit 11B compares the spec information stored in the spec information table 200 to the appropriate spec information stored in the appropriate spec information table 300. For example, the spec comparison unit 11B compares the items 203 to 208 stored in the spec information table 200 to the items 303 to 308 stored in the appropriate spec information table 300 and determines whether or not all the items 203 to 208 match the items 303 to 308, respectively.

The spec updating unit 11C updates, in the spec information, information of the items different from those in the appropriate spec information to information of the items in the appropriate spec information on the basis of a result of the comparison by the spec comparison unit 11B. For example, in FIG. 5 and FIG. 6, in the spec information stored in the spec information table 200 and the appropriate spec information stored in the appropriate spec information table 300, the fluid temperature ranges 204 and 304 are different from each other, the upper limit opening/closing frequencies 205 and 305 are different from each other, and the upper limit flow rates 206 and 306 are different from each other. Accordingly, the information of the fluid temperature range 204, the upper limit opening/closing frequency 205, and the upper limit flow rate 206 of the spec information are updated to the information of the fluid temperature range 304, the upper limit opening/closing frequency 305, and the upper limit flow rate 306 of the appropriate spec information.

The manufacturing condition production unit 11D produces the manufacturing conditions for each of the valve devices 30 on the basis of the spec information stored in the updated spec information table 200. Specifically, manufacturing conditions are produced for the same items (such as the torque value and the diaphragm size) as those of the manufacturing conditions stored in the manufacturing condition table 400. For example, since the gas species 302 is SiH₄, a more stringent test method is selected as the leakage test method 408. When the upper limit opening/closing frequency 205 is changed as a result of the updating of the spec information, the durability of the diaphragm 34 is affected thereby, and accordingly the appropriate torque value 402 is set or the appropriate diaphragm size 403 and appropriate the diaphragm hardness 404 are selected. When the upper limit flow rate 206 is changed, to change the displacement amount of the diaphragm 34, the appropriate torque value 402 is set or the appropriate diaphragm size 403 and the appropriate diaphragm hardness 404 are selected.

The manufacturing condition updating unit 11E updates the manufacturing conditions stored in the manufacturing condition table 400 on the basis of the manufacturing conditions produced by the manufacturing condition production unit 11D.

The instruction information production unit 11F produces the instruction information to be displayed on the display device 3 during the manufacturing of the valve devices 30 on the basis of the manufacturing conditions updated by the manufacturing condition updating unit 11E. For example, the instruction information production unit 11F produces instruction information for displaying a torque value “6.0” on the display device 3 on the basis of the torque value 402 in the manufacturing condition table 400, and produces instruction information for displaying a “Size A” on the display device 3 on the basis of the diaphragm size 403.

The display control unit 11G determines a process of manufacturing the valve devices 30 on the basis of a video received from the camera 2 and transmits the instruction information produced by the instruction information production unit 11F to the display device 3 depending on the manufacturing process.

The information processor 1 of the present embodiment having a configuration as described above performs the instruction information production process in a procedure described below.

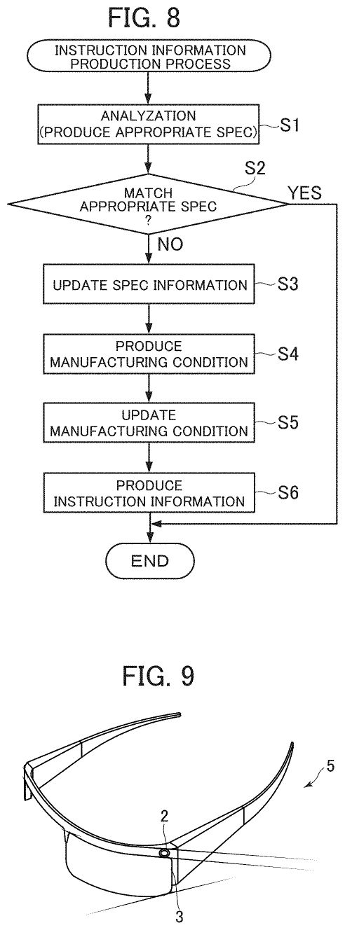

FIG. 8 is a flow chart illustrating the procedure of the instruction information production process.

For example, the instruction information production process executed by the CPU 11 of the information processor 1 is started by a user by executing a program related to the instruction information production process which is stored in the storage unit 12.

First, the analyzation unit 11A analyzes the use information stored in the use information table 100 illustrated in FIG. 4, and stores the appropriate spec information illustrated in FIG. 6 in the appropriate spec information table 300 (Step 51).

The spec comparison unit 11B compares the spec information stored in the spec information table 200 to the appropriate spec information stored in the appropriate spec information table 300 (Step S2). Specifically, the spec comparison unit 11B compares the items 203 to 208 stored in the spec information table 200 to the items 303 to 308 stored in the appropriate spec information table 300, and determines whether or not all the items 203 to 208 match the items 303 to 308, respectively.

When all the items 203 to 208 respectively match the items 303 to 308 (YES in Step S2), the spec comparison unit 11B ends the instruction information production process. In contrast, when any of the items does not match (NO in Step S2), the spec comparison unit 11B advances to Step S3.

The spec updating unit 11C updates the information of the item in the spec information which is different from the corresponding item in the appropriate spec information to the information of the item in the appropriate spec information on the basis of a result of the comparison by the spec comparison unit 11B in Step S2 (Step S3).

The manufacturing condition production unit 11D produces the manufacturing conditions for the valve devices 30 on the basis of the spec information stored in the updated spec information table 200 (Step S4).

The manufacturing condition updating unit 11E updates the manufacturing conditions stored in the manufacturing condition table 400 on the basis of the manufacturing conditions produced by the manufacturing condition production unit 11D (Step S5).

The instruction information production unit 11F produces instruction information to be displayed on the display device 3 during the manufacturing of the valve devices 30 on the basis of the manufacturing conditions updated by the manufacturing condition updating unit 11E (Step S6).

In a device replacement method according to the present embodiment, a valve device is manufactured on the basis of the manufacturing conditions updated by the manufacturing condition updating unit 11E, and the manufactured valve device is replaced with the valve device 30 of the fluid control apparatus 20 for which the use information is acquired. As a result, it is possible to constantly provide valves each having an appropriate spec in accordance with a semiconductor process.

In the information processor 1 described above, the analyzation unit 11A produces the appropriate spec information representing the appropriate spec appropriate for each of the valve devices 30 on the basis of the use information of the valve devices 30. The spec comparison unit 11B compares the appropriate spec information to the spec information representing the predetermined spec. The spec updating unit 11C updates the spec information of the valve devices 30 on the basis of a result of the comparison by the spec comparison unit 11B. The manufacturing condition production unit 11D and the manufacturing condition updating unit 11E produce the manufacturing conditions for the valve devices 30 on the basis of the spec information updated by the spec updating unit 11C. The instruction information production unit 11F produces the instruction information related to the manufacturing of the valve devices to be displayed on the display device 3 on the basis of the manufacturing conditions determined by the manufacturing condition production unit 11D and the manufacturing condition updating unit 11E.

With such a configuration, the manufacturing conditions for manufacturing the valve devices each having the appropriate spec in accordance with the use state of the valve device 30 are produced, and the instruction information related to the manufacturing of the valve devices to be displayed on the display device 3 is produced on the basis of the manufacturing conditions. Accordingly, when there is an order of the same valve device as the valve device 30, it is possible to easily manufacture various valve devices each having the appropriate spec in accordance with the semiconductor process. This can prevent the valve device to have too high specification and suppress an increase in valve device cost. Consequently, the user can obtain a valve device having a spec appropriate to the use environment of the user as long as the valve device is a repeatedly ordered valve device or a valve device manufactured by the same process as used to manufacture the previously ordered valve device.

Also, the analyzation unit 11A produces the appropriate spec information on the basis of the spec information representing the predetermined spec and/or the cumulative information. As a result, when there is an order of the same valve device as the valve device 30, it is possible to easily manufacture various valve devices each having the appropriate spec in accordance with the semiconductor process.

Also, the manufacturing assistance system 10 described above includes the information processor 1 and the display device 3 which displays the instruction information produced by the instruction information production unit 11F to allow an operator thereof to easily manufacture various valve devices, while viewing the display device 3.

The present disclosure is not limited to the embodiment described above. Those skilled in the art will appreciate that various additions, modifications, and the like are possible within the scope of the present disclosure.

For example, in the embodiment described above, the device is the valve device 30, but may also be another fluid control device.

Alternatively, the camera 2 and the display device 3 may also be an integrally configured tablet terminal 4 (FIG. 1). For example, it may also be possible to dispose a tablet terminal 4 between the operator and the valve device 30, display the video recorded by the camera 2 on the display device 3, and thus assist manufacturing. Still alternatively, the information processor 1, the camera 2, and the display device 3 may also be integrally configured.

Still alternatively, as illustrated in FIG. 9, the camera 2 and the display device 3 may also be an integrally configured head-mounted display 5.

What is claimed is:

1. An information processor comprising:
a controller,
wherein the controller is configured to:
produce, on the basis of use information of a device manufactured under a manufacturing condition based on spec information, appropriate spec information representing an appropriate spec which is appropriate to the device; and
determine a manufacturing condition for the device on the basis of the appropriate spec information.

2. The information processor according to claim 1, wherein the controller is configured to:
compare the appropriate spec information to the spec information representing a predetermined spec;
update the spec information of the device on the basis of a comparison result of the appropriate spec information with the spec information; and
produce, on the basis of the manufacturing condition, instruction information related to manufacturing of the device which is to be displayed on a display device.

3. The information processor according to claim 2, wherein the controller is configured to produce the appropriate spec information on the basis of the spec information representing the predetermined spec and/or the appropriate spec information and cumulative information related to the spec information.

4. A manufacturing assistance system comprising:
the information processor according to claim 2; and
a display device which displays the instruction information.

5. The manufacturing assistance system according to claim 4, wherein the display device is configured integrally with an image capturing device.

6. A valve device assembly method using the manufacturing assistance system according to claim 4, wherein
the device is a valve device, and
the manufacturing condition includes at least any one of a physical value of a valve element of the valve device, a size of the valve element, a range of a temperature around the valve device during manufacturing thereof, and a leakage detection method for the valve device.

7. The valve device assembly method according to claim 6, wherein the manufacturing condition includes an amount of stroke of the valve device.
